(19) United States
(12) Patent Application Publication
(10) Pub. No.: US 2024/0359320 A1
(43) Pub. Date: Oct. 31, 2024

(54) METHOD FOR IDENTIFYING SKILLS OF HUMAN-MACHINE COOPERATION ROBOT BASED ON GENERATIVE ADVERSARIAL IMITATION LEARNING

(71) Applicant: Southeast University, Nanjing City (CN)

(72) Inventors: Baoguo XU, Nanjing City (CN); Yifei WANG, Nanjing City (CN); Xin WANG, Nanjing City (CN); Jiajing WANG, Nanjing City (CN); Aiguo SONG, Nanjing City (CN)

(21) Appl. No.: 18/246,860

(22) PCT Filed: Aug. 12, 2022
(86) PCT No.: PCT/CN2022/112008

§ 371 Date: Mar. 28, 2023

(30) Foreign Application Priority Data
Apr. 27, 2022 (CN) 202210451938.X

(51) Int. Cl. B25J 9/16

(52) U.S. Cl. CPC B25J 9/163

(57) ABSTRACT

Disclosed in the present disclosure is a method for identifying skills of a human-machine cooperation robot based on a generative adversarial imitation learning, which includes: firstly, defining classifications of human-machine cooperation skills that needed to be conducted; conducing demonstrations on different classifications of the skills by human experts, and collecting image information and data in the demonstrations to make calibrations; identifying the image information by means of image processing, extracting effective feature vectors capable of clearly distinguishing the different classifications of the skills and taking the effective feature vectors as demonstration teaching data; training a plurality of discriminators respectively by utilizing the acquired demonstration teaching data through a method of the generative adversarial imitation learning; extracting user's data after the training and putting the data into different discriminators, and taking a discriminator corresponding to a maximum value eventually output as an output result of identifying the skills. The present disclosure innovatively combines a computer image recognition with the famous generative adversarial imitation learning in a imitation learning, which has short training time and high learning efficiencies.

### TECHNICAL FIELD

The present disclosure relates to the technical field of human-machine cooperation, and in particular to a method for identifying skills of a human-machine cooperation robot based on a generative adversarial imitation learning.

### BACKGROUND

Cooperative robots are one of development trends of industrial robots in the future, which has advantages of strong ergonomics, strong abilities to perceive environments, high degree of intelligence, and high work efficiencies.

While in the field of the human-machine cooperation, whether agents are capable of determining user's intentions and making corresponding responses are one of standards for determining effectiveness of functions of the human-machine cooperations. In this process, determining the use's intentions and making decisions by the agents is an extremely important step. In the traditional methods, the computer image recognition and processing technology, and the methods such as depth neural networks are used for training, which has problems of many demanded samples and long training time.

### SUMMARY

In order to solve the above problems, the present disclosure discloses a method for identifying skills of a human-machine cooperation robot based on a generative adversarial imitation learning, which innovatively combines a computer image recognition with the famous generative adversarial imitation learning in imitation learning, which has short training time and high learning efficiencies.

In order to achieve the above objectives, the technical solutions of the present disclosure lie in the following.

Provided is a method for identifying skills of a human-machine cooperation robot based on a generative adversarial imitation learning, which includes the following steps.
(1) Classifications of human-machine cooperation skills that needed to be conducted are defined.
(2) Demonstrations on different classifications of the skills are conducted by human experts, image information and data in the demonstrations are collected to make calibrations.
(3) The image information is identified by means of image processing, effective feature vectors capable of clearly distinguishing the different classifications of the skills are extracted and be taken as demonstration teaching data.
(4) A plurality of discriminators are trained respectively by utilizing the acquired demonstration teaching data, through a method of the generative adversarial imitation learning, the number of the discriminators is equal to the number of the skills required for determination.
(5) User's data are extracted after the training and the data are putted into different discriminators, and a discriminator corresponding to a maximum value eventually output is taken as an output result of identifying the skills.

The method of the generative adversarial imitation learning described in Step (4) refers to the following.
(a) Feature vectors are written as the demonstration teaching data.
(b) Strategy parameters and parameters for the discriminators are initialized.
(c) loop iterations are started, and the strategy parameters and the parameters for the discriminators are updated by a gradient descent method and a gradient descent method of confidence intervals, respectively.
(d) The training is ended when a test error reaches a specified value, and the training is completed.
(e) The above training process is performed on each discriminator, separately.

For Step (4), the method of the generative adversarial imitation learning includes two key parts of a discriminator D and a strategy π generator G, with parameters of ω and θ respectively, which are composed of two independent BP neural networks respectively, strategy gradient methods of the two key parts include the following.

The discriminator D (the parameter is the ω) is expressed as a function D_{ω}(s, a), where (s, a) is a set of state action pairs input by the function, and the ω is updated in one iteration according to the gradient descent method, the steps include the following.
(a) A generative strategy is substituted to determine whether an error requirement is satisfied; if yes, it is ended; if no, it is continued.
(b) An expert strategy is substituted, and gradients are obtained according to a formula by substituting output results of the generative strategy and the expert strategy respectively.
(c) The ω is updated according to the gradients.

The strategy π generator G (the parameter is the θ) is expressed as a function G_{θ}(s, a), where (s, a) is a set of state action pairs input by the function, and the θ is updated in one iteration according to the gradient descent method of the confidence intervals, the steps include the following steps.
(a) The strategy is substituted in a previous iteration and gradients are calculated according to a formula.
(b) The θ is updated according to the gradients.
(c) Whether conditions of the confidence intervals is satisfied is determined.
(d) If yes, a next iteration is entered; if no, a learning rate is reduced and Step (b) is repeated.

The beneficial effects of the present disclosure lie in the following.

A method for identifying skills of a human-machine cooperation robot based on a generative adversarial imitation learning in the present disclosure solves the problems of a low efficiency of robot's skill recognition for human users in a human-computer interaction, in combination with an algorithm of the generative adversarial imitation learning in an imitation learning, has the advantages of short training time and high learning efficiency. The method not only solves the problem of cascading errors in behavior cloning, but also solves the problem of excessive demands for computing performance in an inverse reinforcement learning, and has a certain generalization performance.

### BRIEF DESCRIPTION OF THE DRAWINGS

FIG. 1 illustrates a schematic diagram of a demonstration teaching picture for pouring water by a robot arm.

FIG. 2 illustrates a schematic diagram of a demonstration teaching picture for delivering an object by the robot arm.

FIG. 3 illustrates a schematic diagram of a demonstration teaching picture for placing an object by the robot arm.

FIG. 4 illustrates a schematic diagram of a picture extracted by a HOPE-Net algorithm.

FIG. 5 illustrates a flowchart of an algorithm part.

FIG. 6 illustrates a structure schematic diagram of a neural network.

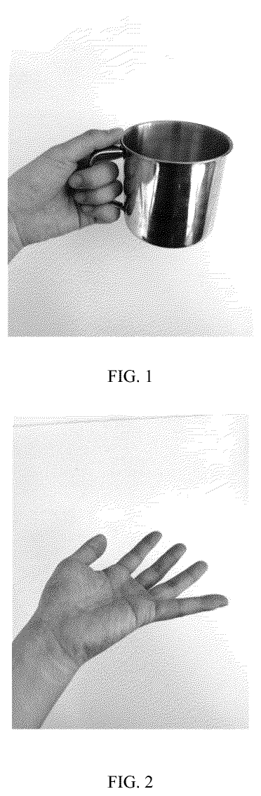

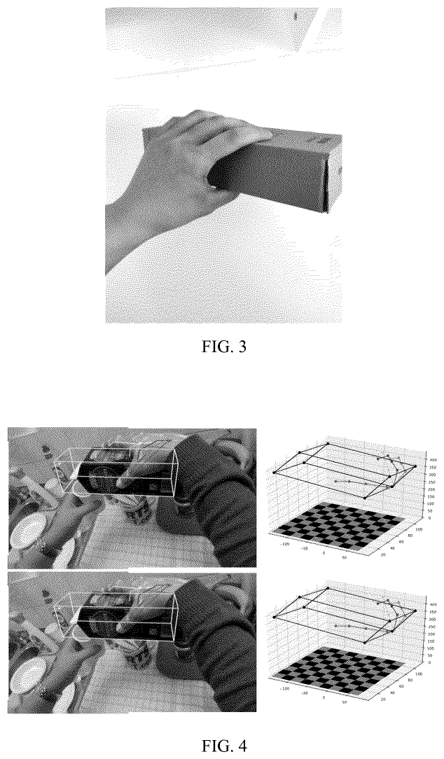

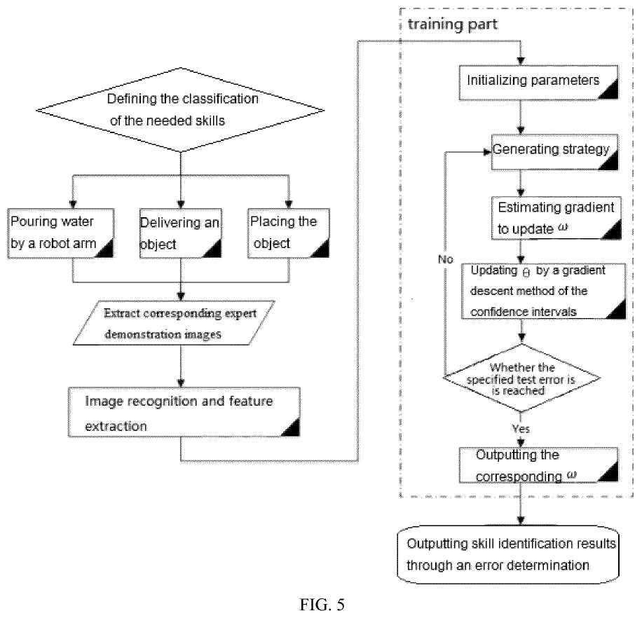

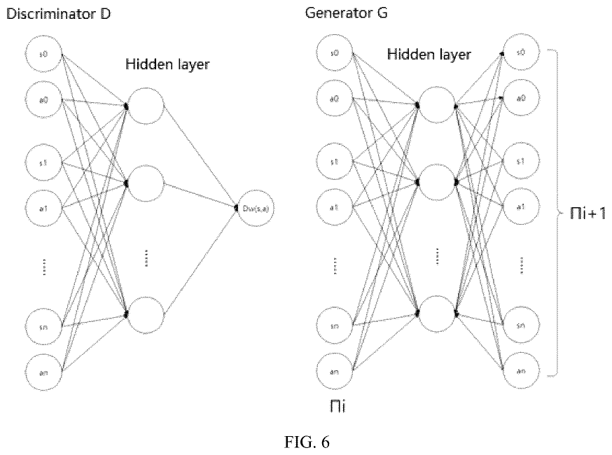

### DETAILED DESCRIPTION OF THE EMBODIMENTS

The present disclosure will be further clarified in conjunction with the accompanying drawings and the specific embodiments. It should be understood that the following specific embodiments are only used to illustrate the present disclosure and not to limit the scope of the present disclosure.

Agents mentioned in the present disclosure refers to non-human learners who carry out a training process of machine learning and have abilities to output decisions. Experts mentioned in the present disclosure refers to human experts who provide guidance at an agent training stage. Users mentioned in the present disclosure refers to human users who use after intelligent agents complete the training.

For a method for identifying skills of a human-machine cooperation robot based on a generative adversarial imitation learning, the method includes the following steps.

(1) Classifications of human-machine cooperation skills that needed to be conducted are defined. This implementation method takes three types of tasks, namely, pouring water by a robot arm, delivering an object by the robot arm, and placing the object by the robot arm, as examples to illustrate the implementation steps.

(2) The expert demonstrates the three types of actions several times, corresponding to three different tasks that the robot arm is expected to perform, which includes pouring water by a robot arm, delivering an object by the robot arm, and placing the object by the robot arm. A task of pouring water pouring by the robot arm requires the expert to hold a cup at a center of a picture for a period of time. A task of delivering the object requires the expert to expand palms and hold at the center of the picture for a period of time. A task of placing the object requires the expert to hold an object to be placed at the center of the picture for a period of time.

(3) A HOPE-Net algorithm is adopted to identify gestures of the expert's hand in extracted picture, processed features are expressed in a form of vector, they are saved as demonstration teaching data after three types are calibrated by the experts.

(4) The agents are trained separately by three groups of demonstration teaching data and an algorithm of the generative adversarial imitation learning, and three groups of parameters are respectively obtained.

Step (4) includes the following sub-steps.

(4.1) Vectors of a first set of the demonstration teaching data of the expert are written, and the corresponding action is pouring water by the robot arm, which is expressed as

x_{E}=(x₁,x₂, . . . ,xₙ),

where x_{E} is the demonstration teaching data of the expert, and x₁, x₂, . . . , xₙ respectively represents coordinates of important points at the expert's hand. Assuming that 15 coordinates are taken at one hand and are collected every 0.1 seconds for a total time of 3 seconds, there are 450 coordinates in x_{E}.

(4.2) Strategy parameters θ₀ and parameters for discriminators coo are initialized.

(4.3) Loop iterations are started for i=0, 1, 2, . . . , where i is the counting on the number of loops, and the value of 1 is added each loop, where a, b, and c are loop bodies in turn.
(a) Strategies πᵢ and coordinates xᵢ are generated by utilizing a parameter of θᵢ.
(b) ω is updated by utilizing a gradient descent method for ωᵢ to ωᵢ₊₁, where a gradient is

$${\hat{E}}_{{x}_{i}} [ {∇}_{ω} log ( {D}_{ω} ( s , a ) ) ] + {\hat{E}}_{{x}_{E}} ( {∇}_{ω} log ( 1 - {D}_{ω} ( s , a ) ) ) ,$$

where Ê is an estimated expectation of a distribution, the subscript represents a certain distribution, ∇_{ω} is calculating the gradient for the ω, D_{ω}(s, a) is a probability density of the discriminator under the parameter ω, (s, a) is an input of a probability density function of the discriminator that is a state action pair. In this embodiment, s is a coordinate, a represents a relative position change of two adjacent coordinates, which is capable of being expressed in a spherical coordinate system.
(c) The θ is updated by utilizing a gradient descent method of confidence intervals for θᵢ to θᵢ₊₁, where the gradient is

$${\hat{E}}_{{x}_{i}} [ {∇}_{θ} log {π}_{θ} ( s \vert a ) Q ( s , a ) ] - λ {∇}_{θ} H ( {π}_{θ} ) ,$$

and the gradient satisfies the following confidence intervals at the same time.

$${\overline{D}}_{KL} ( {π}_{{θ}_{i}} ‖ {π}_{{θ}_{i + 1}} ) \leq Δ ,$$

where a function of Q is defined as

$$Q ( \overline{s} , \overline{a} ) = {\hat{E}}_{{x}_{i}} [ log ( {D}_{{ω}_{i + 1}} ( s , a ) ) \vert {s}_{0} = \overline{s} , {a}_{0} = \overline{a} ] ,$$

where D̅_{KL} (π_{θ}_{ᵢ}∥π_{θ}_{ᵢ₊₁}) is an average value for KL divergences of the two, which is defined as

$${\overline{D}}_{KL} ( {π}_{{θ}_{i}} ‖ {π}_{{θ}_{i + 1}} ) = {E}_{s \sim {ρ}_{{π}_{{θ}_{i}}}} [ {D}_{KL} ( {π}_{{θ}_{i}} ( \cdot \vert s ) ‖ {π}_{{θ}_{i + 1}} ( \cdot \vert s ) ) ] ,$$

where λ is a regularization term of an entropy regularization, H represents an entropy, H(π) [symbol] E_{π}(−log π(a|s)), Δ is a preset constant in advance, and

$${ρ}_{{π}_{{θ}_{i}}}$$

is a frequency of a state access under a strategy π_{θ}_{ᵢ}.

(4.4) Training is ended when a test error reaches a specified value, the loops are ended, and so on. The remaining two groups of data are trained by adopting the above algorithm respectively. Eventually, for the three skills, the corresponding ω is respectively obtained according to the results of the iteration in the above algorithms, which is represented by ω₁, ω₂ and ω₃.

(5) After the training is completed, user's actions are capable of being identified and decisions is capable of being made on which of the three skills to take.

Step (5) includes the following sub-steps respectively.

(5.1) Three corresponding discriminator functions D_{ω}_{₁}, D_{ω}_{₂}, and D_{ω}_{₃} are written according to the ω₁, the ω₂, and the ω₃.
(a) Pouring water by the robot arm is C₁=D_{ω}_{₁}(s, a).
(b) Delivering the object by the robot arm is C₂=D_{ω}_{₂}(s, a).
(c) Placing the object by the robot arm is C₃=D_{ω}_{₃}(s, a).

(5.2) The data for the user's hand are extracted and are written in a vector form of xᵤₛₑᵣ=(x₁, x₂, . . . , xₙ).

(5.3) The xᵤₛₑᵣ is substituted into a loss function in the (5.1) respectively and arg_{iϵ{1,2,3}}max Cᵢ(xᵤₛₑᵣ) is found out.

The eventual result iϵ{1,2,3} is to make three decisions corresponding to the intelligent agents, namely, pouring water by the robot arm, delivering the object by the robot arm, and placing the object by the robot arm.

For Step (4), the method of the generative adversarial imitation learning includes two key parts of a discriminator D (the parameter is the ω) and a strategy π generator G (the parameter is the θ), which are composed of two independent BP neural networks respectively, strategy gradient methods of the two key parts include the following.

The discriminator D (the parameter is the ω) is expressed as a function D_{ω}(s, a), where (s, a) is a set of state action pairs input by the function, and the ω is updated in one iteration according to the gradient descent method, the steps include the following.
(a) Given is (s, a)←πᵢ to determine whether a network output D satisfies result requirements, if yes, it is ended; if no, it is continued.
(b) A term Êₓ_{ᵢ}[∇_{ω} log(D_{ω}(s, a))] in the gradient is derived.
(c) Given is (s, a)←π_{E}, and a term Êₓ_{_{E}}(∇_{ω} log(1−D_{ω}(s, a))) in the gradient is derived.
(d) The parameter w is updated according to a method for updating BP algorithm parameters, and ωᵢ₊₁=ωᵢ+η∇ is satisfied, where η is a learning rate, and ∇ represents the gradient.

The strategy π generator G (the parameter is θ) is expressed as a function G_{θ}(s, a), where (s, a) is a set of state action pairs input by the function, and the θ is updated in one iteration according to the gradient descent method of the confidence intervals, which has the following steps.
(a) The gradient is calculated by Êₓ_{ᵢ}[∇_{θ} log π_{θ}(s|a)Q(s, a)]−λ∇_{θ}H(π_{θ}).
(b) The parameter θ is updated according to the method for updating BP algorithm parameters, and θᵢ₊₁=θᵢ+π∇ is satisfied, where the η is the learning rate, and the ∇ represents the gradient.
(c)

$${\overline{D}}_{KL} ( {π}_{{θ}_{i}} ‖ {π}_{{θ}_{i + 1}} ) = {E}_{s \sim {ρ}_{{π}_{{θ}_{i}}}} [ {D}_{KL} ( {π}_{{θ}_{i}} ( \cdot \vert s ) ‖ {π}_{{θ}_{i + 1}} ( \cdot \vert s ) ) ]$$

is calculated and whether conditions of the confidence intervals D̅_{KL}(π_{θ}_{ᵢ}∥π_{θ}_{ᵢ₊₁}) A are satisfied is determined.
(d) If the conditions of the confidence intervals are satisfied, a next iteration is entered. If the conditions are not satisfied, the η is reduced and Step (b) is repeated.

It should be noted that the above contents only express the technical ideas of the present disclosure and it should not be understood as a limitation on the protection scope of the present disclosure. For ordinary technicians in the art, some changes and improvements can be made without departing from the concepts of the present disclosure, which are all within the protection scope of the present disclosure.

What is claimed is:

1. A method for identifying skills of a human-machine cooperation robot based on a generative adversarial imitation learning, wherein the method comprises following steps:
(1) defining classifications of human-machine cooperation skills that needed to be conducted;
(2) conducing, by human experts, demonstrations on different classifications of the skills, and collecting image information and data in the demonstrations to make calibrations;
(3) identifying, by means of image processing, the image information, extracting effective feature vectors capable of clearly distinguishing the different classifications of the skills and taking the effective feature vectors as demonstration teaching data;
(4) training, by utilizing the acquired demonstration teaching data, a plurality of discriminators respectively, through a method of the generative adversarial imitation learning, wherein a number of the discriminators is equal to a number of the skills required for determination; and
(5) extracting, after the training, user's data, and putting the data into different discriminators, and taking a discriminator corresponding to a maximum value eventually output as an output result of identifying the skills.

2. The method for identifying the skills of the human-machine cooperation robot based on the generative adversarial imitation learning according to claim 1, wherein the method of the generative adversarial imitation learning described in Step (4) refers to:
(1) writing feature vectors as the demonstration teaching data;
(2) initializing strategy parameters and parameters for the discriminators;
(3) starting loop iterations, and updating, by a gradient descent method and a gradient descent method of confidence intervals respectively, the strategy parameters and the parameters for the discriminators;
(4) ending, when a test error reaches a specified value, the training, and completing the training; and
(5) performing the above training process on each discriminator, respectively.

3. The method for identifying the skills of the human-machine cooperation robot based on the generative adversarial imitation learning according to claim 1, wherein for Step (4), the method of the generative adversarial imitation learning includes two key parts of a discriminator D and a strategy π generator G with parameters ω and θ respectively, which are composed of two independent BP neural networks respectively, strategy gradient methods of the two key parts are as follows:
expressing the discriminator D as a function D_{ω}(s, a), where (s, a) is a set of state action pairs input by the function, and updating, according to the gradient descent method, the ω in one iteration, which includes following steps:
(a) substituting a generative strategy to determine whether an error requirement is satisfied; if yes, ending; if no, continuing;
(b) substituting an expert strategy, obtaining, by substituting output results of the generative strategy and the expert strategy respectively, gradients according to a formula; and
(c) updating the ω according to the gradients; and
expressing the strategy π generator G as a function G_{θ}(s, a), where (s, a) is a set of state action pairs input by the function, and updating, according to the gradient descent method of the confidence intervals, the θ in one iteration, which includes follows steps:
(a) substituting the strategy in a previous iteration and calculating gradients according to a formula;
(b) updating the θ according to the gradients;
(c) determining whether conditions of the confidence intervals are satisfied; and
(d) if yes, entering a next iteration; if no, reducing a learning rate and repeating Step (b).
